(19) United States
(12) Patent Application Publication
(10) Pub. No.: US 2005/0125563 A1
(43) Pub. Date: Jun. 9, 2005

(54) Load balancing device communications

(76) Inventor: Chet R. Douglas, Bisbee, AZ (US)

Correspondence Address: INTEL CORPORATION, P.O. BOX 5326, SANTA CLARA, CA, 95056-5326, US

(21) Appl. No.: 10/732,739

(22) Filed: Dec. 9, 2003

(51) Int. Cl. G06F 15/16

(52) U.S. Cl. 709/250

(57) ABSTRACT

One embodiment of a method may include setting an initial bandwidth limit for each of a plurality of active devices associated with a controller. The method may additionally include determining a total amount of extra bandwidth from the plurality of active devices that have extra bandwidth, and determining a number of the plurality of active devices that require extra bandwidth. If there is extra bandwidth, and one or more of the plurality of active devices require extra bandwidth, adjusting the bandwidth limit by reallocating the extra bandwidth to the one or more plurality of active devices that require extra bandwidth, the adjusting resulting in a bandwidth limit corresponding to each of the plurality of active devices.

### FIELD

Embodiments of this invention relate to load balancing device communications.

### BACKGROUND

Embodiments of the invention may relate to controllers that may manage communications sent to one or more other devices (hereinafter referred to as “devices”). For example, an I/O (input/output) storage controller may control the sending and receiving of I/O requests between computer systems (and/or components on computer systems), for example, and peripheral storage devices. Since controllers may have a finite amount of bandwidth that is available for managing communications to devices at a given time, it is important to appropriately balance the available controller bandwidth among the devices.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network.

FIG. 2 illustrates a system.

FIG. 3 illustrates a system embodiment.

FIG. 4 is a flowchart illustrating a method embodiment.

FIGS. 5-8 illustrate a first example according to an exemplary embodiment.

FIGS. 9-12 illustrate a second example according to an exemplary embodiment.

### DETAILED DESCRIPTION

Embodiments of the present invention include various operations, which will be described below. The operations associated with embodiments of the present invention may be performed by hardware components or may be embodied in machine-executable instructions, which when executed may result in a general-purpose or special-purpose processor or circuitry programmed with the instructions performing the operations. Alternatively, and/or additionally, some or all of the operations may be performed by a combination of hardware and software.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing such instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Introduction

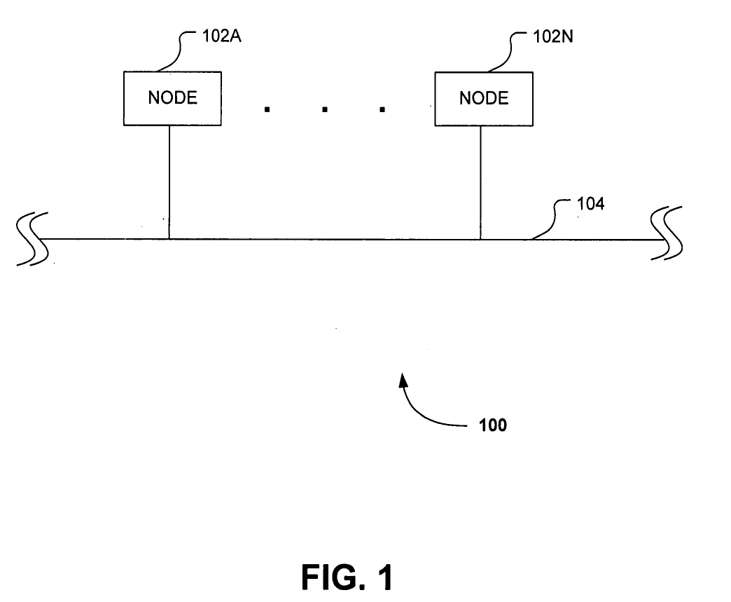

FIG. 1 illustrates one example of a network 100 in which embodiments of the invention may be carried out. Network 100 may comprise, for example, one or more computer nodes 102A . . . 102N (hereinafter “nodes”) communicatively coupled together via a communication medium 104. Nodes 102A . . . 102N may transmit and receive sets of one or more signals via medium 104 that may encode one or more packets. As used herein, a “packet” means a sequence of one or more symbols and/or values that may be encoded by one or more signals transmitted from at least one sender to at least one receiver.

As used herein, a “communication medium” 104 means a physical entity through which electromagnetic radiation may be transmitted and/or received. Medium 104 may comprise, for example, one or more optical and/or electrical cables, although many alternatives are possible. For example, medium 104 may comprise, for example, air and/or vacuum, through which nodes 102A . . . 102N may wirelessly transmit and/or receive sets of one or more signals.

In network 100, one or more of the nodes 102A . . . 102N may comprise one or more intermediate stations, such as, for example, one or more hubs, switches, and/or routers; additionally or alternatively, one or more of the nodes 102A . . . 102N may comprise one or more end stations. Also additionally or alternatively, network 100 may comprise one or more not shown intermediate stations, and medium 104 may communicatively couple together at least some of the nodes 102A . . . 102N and one or more of these intermediate stations. Of course, many alternatives are possible.

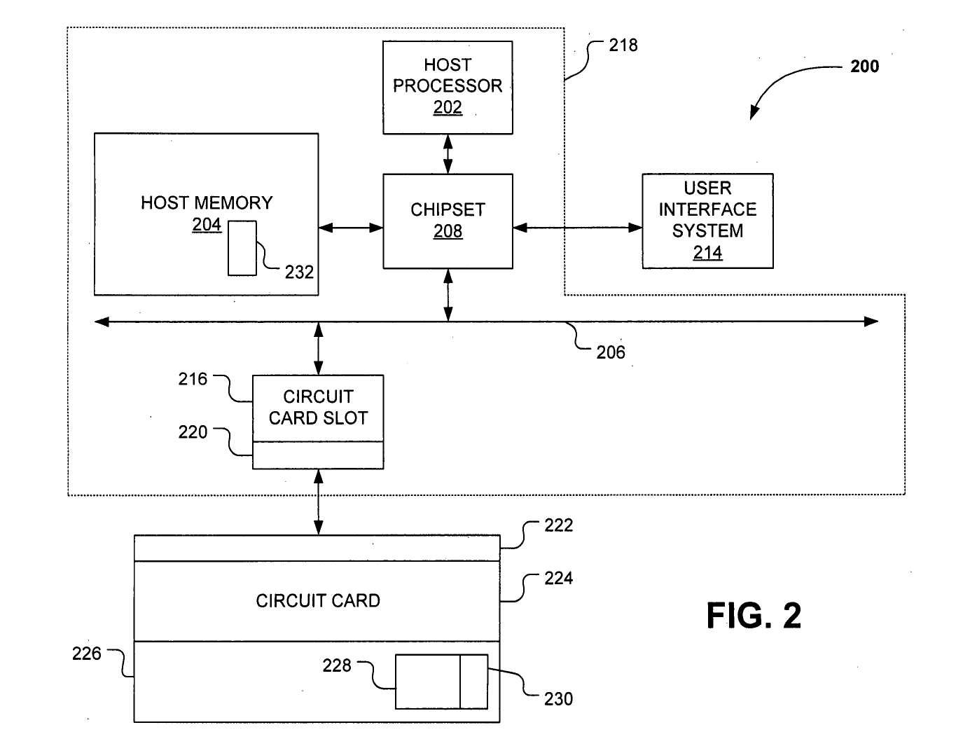

FIG. 2 illustrates system 200. System 200 may be a node 102A . . . 102N in network. 100. System 200 may comprise host processor 202, host memory 204, bus 206, and chipset 208. Host processor 202 may be coupled to chipset 208. Host processor 202 may comprise, for example, an Intel® Pentium® III or IV microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Chipset 208 may comprise a host bridge/hub system that may couple host processor 202, host memory 204, and a user interface system 214 to each other and to bus 206. Chipset 208 may also include an I/O bridge/hub system (not shown) that may couple the host bridge/bus system 208 to bus 206. Chipset 208 may comprise one or more integrated circuit chips, such as those selected from integrated circuit chipsets commercially available from the Assignee of the subject application (e.g., graphics memory and I/O controller hub chipsets), although other one or more other integrated circuit chips may also, or alternatively, be used. User interface system 214 may comprise, e.g., a keyboard, pointing device, and display system that may permit a human user to input commands to, and monitor the operation of, system 200.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 206 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also, alternatively, bus 206 may comprise other types and configurations of bus systems.

System 200 may comprise one or more memories to store program instructions 230, 232 capable of being executed, and/or data capable of being accessed, operated upon, and/or manipulated by processor, such as host processor 202, and/or circuitry, such as circuitry 226. These one or more such memories may include, for example host memory 204, and/or memory 228 in circuitry 226. Memories 204, 228 may comprise read only, mass storage, and/or random access computer-readable memory. The execution of program instructions 230, 232 and/or the accessing, operation upon, and/or manipulation of this data by the host processor 202 and/or circuitry 226 may result in, for example, host processor 202 and/or circuitry 226 carrying out the operations described herein as being carried out by host processor 202 and/or circuitry 226.

Host processor 202, host memory 204, bus 206, chipset 208, and circuit card slot 216 may be comprised in a single circuit board, such as, for example, a system motherboard 218. Circuit card slot 216 may comprise a PCI expansion slot that comprises a PCI bus connector 220. PCI bus connector 220 may be electrically and mechanically mated with a PCI bus connector 222 that is comprised in circuit card 224. Circuit card slot 216 and circuit card 224 may be constructed to permit circuit card 224 to be inserted into circuit card slot 216. When circuit card 224 is inserted into circuit card slot 216, PCI bus connectors 220, 222 may become electrically and mechanically coupled to each other. When PCI bus connectors 220, 222 are so coupled to each other, circuitry 226 in circuit card 224 may become electrically coupled to bus 206.

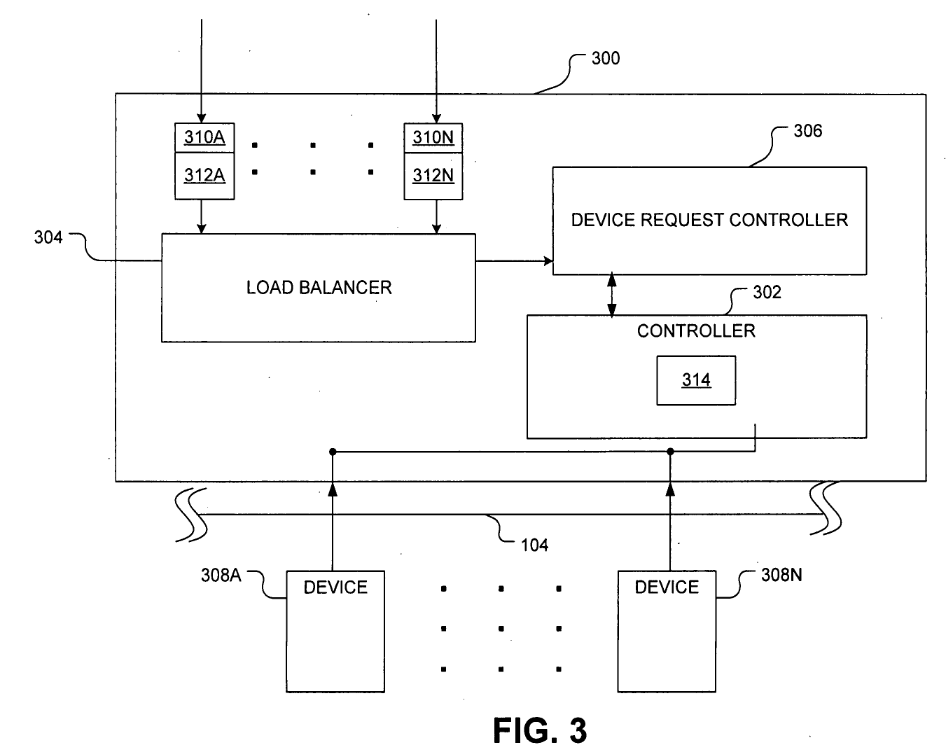

FIG. 3 illustrates a system embodiment of the invention that may be implemented in one or more components of system 200. System 300 may include controller 302, and load balancer 304. System 300 may be a computer system, such as system 200 that may communicate with one or more devices 308A . . . 308N. System 300 and one or more devices 308A . . . 308N may each be a node 102A . . . 102N in network 100 that may communicate via medium 104. Additionally or alternatively, one or more devices 308A . . . 308N may be directly connected to system 300.

A “device” 308A . . . 308N means a machine or a process that may send and receive one or more communications via controller 302. Device 308A . . . 308N may comprise, for example, a hardware component, such as a disk drive or any type of storage peripheral, where the device may be connected to system 300 directly or via a network; a software process, such as an application program; or even a virtual device. Each device 308A . . . 308N may each be associated with a device request queue to 312A . . . 312N on system 300 to store one or more communications destined for device 308A . . . 308N. Each device 308A . . . 308N may also be associated with a priority 310A . . . 310N.

A “communication”, as used herein, means data from a sending device that may be destined for one or more devices 308A . . . 308N via controller 302. “Sending device”, as used herein, may comprise a system, such as system 300, another system, such as system 200, and/or one or more hardware and/or software components, such as an operating system, on a system, such as system 200, 300. For example, data may comprise a request to store data on storage media (not shown) associated with devices 308A . . . 308N. More generally, however, communication means data 300 sent via controller 302. In embodiments of the invention, data may comprise storage requests. However, embodiments of the invention are not limited to data of this type.

“Controller” 302 refers to a device that may manage one or more communications from a sending device to one or more devices 308A . . . 308N. In one embodiment, controller 302 may be associated with controller request queue 314 to store one or more communications removed from device request queue 312A . . . 312N to be transmitted to one or more devices 308A . . . 308N by controller 302. Controller request queue 314 may be a memory, such as memory 204, that may store one or more communications to be sent to devices 308A . . . 308N.

Load balancer 304 may balance the available controller bandwidth across one or more active devices 308A . . . 308N. An “active device” is a device which may have one or more communications in controller request queue 314, or which may have one or more communications in device request queue 312A . . . 312N. Conversely, an inactive device is a device that does not have any outstanding communications in the controller's request queue 314, or any communications in device request queue 312A . . . 312N.

In one embodiment, bandwidth may be measured in terms of the number of I/O requests that controller 302 can handle, or the number of I/O requests that each device 308A . . . 308N can have outstanding in controller request queue 314. In embodiments of the invention, load balancer 304 may run at predetermined intervals, for example. Embodiments of the invention are not limited to predetermined intervals, however, and load balancer 304 may run in accordance with other periods without departing from embodiments of the invention. As used herein, each time that load balancer 304 runs may be referred to as an iteration.

Controller 302 may be comprised, for example, in a combination of hardware and firmware. For example, controller 302 may be comprised in a chipset, such as chipset 208. Also, for example, controller 302 may be comprised in circuit card 224 that may be inserted into a circuit card slot 216 on system motherboard 218, for example. Some or all of controller 302 functionality may be programmed and stored in computer-readable memory, such as memory 204, or memory 228.

Load balancer 304 and/or device request controller 306 may be comprised in software. Load balancer 304 functionality and/or device request controller functionality 306 may be programmed and stored in computer-readable memory, such as in host memory 204, or memory 228. Many alternatives are possible. For example, load balancer 304 and device request controller 306 may both be comprised in a single circuit card, such as circuit card 224 that may be inserted into circuit card slot, such as circuit card slot 216. Alternatively, load balancer 304 and device request controller 306 may be individually comprised in a single circuit card, such as circuit card 224 that may be inserted into circuit card slot, such as circuit card slot 216. Alternatively, load balancer 304 and device request controller 306 may be part of a chipset, such as chipset 208. For example, load balancer 304 and device request controller 306 may be part of a controller chipset 208.

In one embodiment, as illustrated below, controller 302 may be a storage controller for one or more devices 308A . . . 308N, such as peripheral storage devices. In one embodiment, controller 302 may manage one or more I/O requests to one or more devices 308A . . . 308N. Additionally in this embodiment, system 300 may additionally comprise device request controller 306 to manage controller request queue 314. The amount of controller 302 bandwidth load balancer 304 may allocate to each device 308A . . . 308N may be reported to device request controller 306. Device request controller 306 may use this allocation to control how many requests from device request queue 312A . . . 312N are removed and added to controller request queue 314. For example, if a device 308A . . . 308N has not exceeded its bandwidth limit, then device request controller 306 may take a request from the device request queue 312A . . . 312N, and place it in controller request queue 314. Device request controller 306 may increment the number of requests on device request queue 312A . . . 312N in accordance with requests that system 300 has received. Device request controller 306 may decrement the number of requests on device request queue 312A . . . 312N in accordance with requests that have been removed from device request queue 312A . . . 312N and placed in controller request queue 314 to be sent to device 308A . . . 308N. Device request controller 306 may service each device 308A . . . 308N in round robin order; however, many alternatives are possible.

In one embodiment, as illustrated below, load balancer 304 may be part of a software driver for an operating system, such as for system 300, for example. The operating system software driver may communicate with controller 302 that may service one or more devices 308A . . . 308N, and may balance the communication load from controller 302 to one or more devices 308A . . . 308N. Alternatively, load balancer 304 may be part of the controller 302, and controller 302 may balance the communication load sent to one or more devices 308A . . . 308N from another component on system 300. Another alternative is that load balancer 304 may be part of an operating system software driver that may balance the communication load sent to one or more devices 308A . . . 308N from another software driver.

Illustrative embodiments may describe load balancer 304 as balancing I/O requests on controller 302 sent to one or more devices 308A . . . 308N. In these embodiments, embodiment-specific terms may be used for illustrative purposes. However, terms, such as I/O requests, are not intended to limit embodiments of the invention. The terms, instead, should aid in one's understanding of embodiments of the invention, and how embodiments of the invention may be applicable in other scenarios.

In one illustrated embodiment, it may be assumed that there are devices 308A . . . 308N represented by notations 0-N associated with a controller 302, where any given one of the 0-N devices may be arbitrarily represented by the notation M. The following variables, constants, and/or terms may be used by load balancer 304 in accordance with embodiments of the invention:

ACTIVE DEVICE may represent a device 308A . . . 308N that has a TOTAL REQUESTED BANDWIDTH>0.

ACTIVE BANDWIDTH[M] may represent a number of requests for device M that have been sent to controller 302, and are outstanding on controller request queue 314 for device M. This number should remain less than or equal to the ACTIVE BANDWIDTH LIMIT[M] (see below).

ACTIVE BANDWIDTH LIMIT[M] may represent a maximum amount of bandwidth (i.e., number of requests in one embodiment) that may be active on controller request queue 314 for device M. During an iteration, this may represent the initial bandwidth allotment for each active device, which may be the greater of the AVG BANDWIDTH and the MIN BANDWIDTH. During the iteration, this value may be incremented for devices 308A . . . 308N that require extra bandwidth, and decremented for devices 308A . . . 308N that have extra bandwidth.

AVG BANDWIDTH may represent an amount of bandwidth (i.e., number of requests in one embodiment) allocated to each active device based on the maximum bandwidth (MAX BANDWIDTH) and the number of active devices (ACTIVE DEVICE). If this amount is greater than MIN BANDWIDTH, the initial bandwidth allotment (ACTIVE BANDWIDTH LIMIT[M]) is set to AVG BANDWIDTH.

DEVICE COUNT may initially represent a number of active devices. This number is subsequently reset to 0, and may then represent the number of devices requiring more bandwidth.

GIVE BANDWIDTH[M] may represent an amount of bandwidth (i.e., number of requests in one embodiment) below the initial bandwidth allotment to device M, that is not required by device M.

INACTIVE DEVICE: may represent a device that has a TOTAL REQUESTED BANDWIDTH=0.

MAX BANDWIDTH may be the maximum amount of bandwidth (i.e., number of requests in one embodiment) that controller 302 can handle, and may be reported by controller 302. This represents the maximum number of communications requests that can be queued to controller request queue 314 at any given point in time. Thus, the total of ACTIVE BANDWIDTH LIMIT[M] for all devices should be less than or equal to MAX BANDWIDTH.

MIN BANDWIDTH may represent an amount of bandwidth (i.e., number of requests in one embodiment) that may be guaranteed to each device 308A . . . 308N. This may be a predetermined number, or a dynamically determined number. If AVG BANDWIDTH is less than MIN BANDWIDTH, the initial bandwidth allotment (ACTIVE BANDWIDTH LIMIT[M]) is set to MIN BANDWIDTH.

PRIORITY[M] may indicate that device M is associated with a priority. In embodiments of the invention, controller 302 may determine that a device 308A . . . 308N is a priority device, and may associate the device with a priority 3.1A . . . 310N (hereinafter “priority device”). In one embodiment, controller 302 may associate a device 308A . . . 308N with a priority 310A . . . 310N by setting the device's priority flag (e.g., PRIORITY[M]=1). In other embodiments, controller 302 may associate the device 308A . . . 308N with a priority 310A . . . 310N by assigning a priority to the device, for example. This flag (or priority assignment) may indicate that a device should be allocated more bandwidth because a request associated with that device is a high priority request. For example, a device may be a priority device if a request is sent to the device, and controller 302 knows that the device contains the operating system, in which case controller 302 may associate the device with a priority. PRIORITY[M] may result in load balancer 304 behaving differently for devices that have their PRIORITY[M] flags set (e.g., PRIORITY[M]=1) versus devices that do not (e.g., PRIORITY[M]=0). In other embodiments, PRIORITY[M] may have a value other than set or disabled (0, 1). For example, PRIORITY[M] may indicate a priority level, such that a higher priority level may allow more bandwidth to be allocated to the corresponding device.

PRIORITY COUNT may represent the number of priority devices.

QUEUE BANDWIDTH[M] may represent a number of requests that have been queued to device request queue, 312A . . . 312N. This value may be incremented each time a request is added to device request queue 312A . . . 312N, and decremented each time a request is removed from device request queue 312A . . . 312N.

RES BANDWITH may be an amount that is set aside to allow any device 308A . . . 308N to get bandwidth at any time to avoid request latency. For example, if a device 308A . . . 308N is not taken into account during an iteration, and subsequently (to the current iteration, but before a subsequent iteration) requests bandwidth, then the device 308A . . . 308N may use up to RES BANDWIDTH. Put another way, RES BANDWIDTH is an amount of bandwidth set aside for one or more devices 308A . . . 308N that may be initially inactive during an iteration. This may be a predetermined number, such as for each iteration, or a dynamically determined number that may be changed for different iterations, for example.

TOTAL REQUESTED BANDWIDTH[M] may represent the total of the amount of bandwidth in device M's request queue 312A . . . 312N (QUEUE BANDWIDTH[M]) and the amount of bandwidth in controller request queue 314 for device M (ACTIVE BANDWIDTH[M]).

TOTAL EXTRA BANDWIDTH may represent the total amount of extra bandwidth that is not being utilized by the active devices.

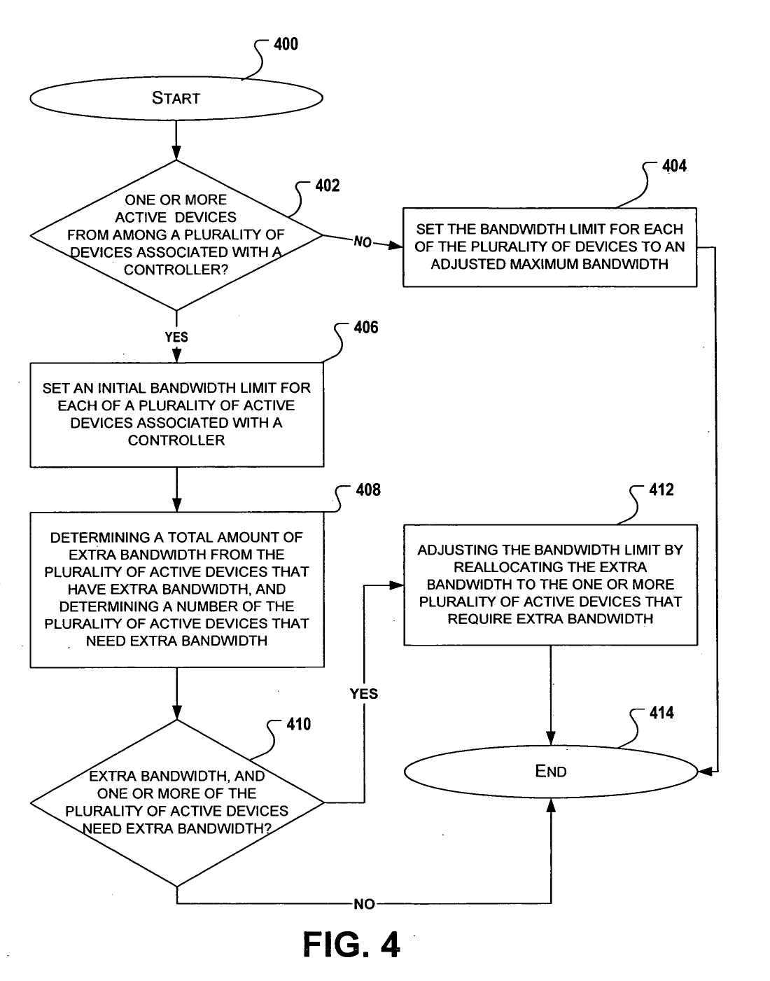

FIG. 4 is a flowchart illustrating one embodiment, where each block may illustrate one or more operations that may be performed by load balancer 304. The description of the method set forth below may refer to the variables, constants, and/or terms described above. These variables, constants, and/or terms are shown in capitalized text.

The method begins at block 400 and continues to block 402 where load balancer 304 may determine if there are one or more active devices from among a plurality of devices 308A . . . 308N associated with controller 302 (the number of active devices may be represented by DEVICE COUNT). In one embodiment of the invention, a device may be active if its total requested bandwidth (TOTAL REQUESTED BANDWIDTH[M]) is greater than 0.

At block 404, if none of the devices 308A . . . 308N are active, then load balancer 304 may set the bandwidth limit (ACTIVE BANDWIDTH LIMIT[M]) for each of the plurality of devices to an adjusted maximum bandwidth. In one embodiment, the adjusted maximum bandwidth may comprise a portion of the maximum bandwidth (MAX BANDWIDTH). As discussed above, the adjusted maximum bandwidth may comprise the difference between the maximum bandwidth (MAX BANDWIDTH), and a reserved bandwidth (RES BANDWIDTH). The method then ends at block 416.

At block 406, if one or more of the devices 308A . . . 308N is active, then load balancer 304 may set an initial bandwidth limit (ACTIVE BANDWIDTH LIMIT[M]) for each of a plurality of active devices associated with controller 302. In one embodiment, the initial bandwidth limit may be set to the greater of an average bandwidth (AVG BANDWIDTH) and a minimum bandwidth (MIN BANDWIDTH). In one embodiment, the average bandwidth (AVG BANDWIDTH) may be set to the difference between the maximum bandwidth and a reserved bandwidth (RES BANDWIDTH) divided by the number of active devices (DEVICE COUNT).

At block 408, load balancer 304 may determine a total amount of extra bandwidth (TOTAL EXTRA BANDWIDTH) from the plurality of active devices that have extra bandwidth, and a number of the active devices that require extra bandwidth. Load balancer 304 may determine the total amount of extra bandwidth by determining which of the active devices have extra bandwidth, and how much for each of those devices (GIVE BANDWIDTH[M]). Load balancer 304 may determine the number of active devices that require extra bandwidth by determining which of the active devices require more bandwidth than initially allocated (TOTAL REQUESTED BANDWIDTH[M]<initial bandwidth allotment), and which of the active devices are associated with a priority (PRIORITY[M]=1).

At block 410, load balancer 304 may determine if there is extra bandwidth, and if there are one or more of the plurality of active devices that require extra bandwidth. In embodiments of the invention, there is extra bandwidth if TOTAL EXTRA BANDWDITH>0, and there are devices that require extra bandwidth if DEVICE COUNT>0 or PRIORITY COUNT>0. If there is no extra bandwidth and/or there are no devices that require extra bandwidth, then the method ends at block 414.

At block 412, if there is extra bandwidth and if one or more of the plurality of active devices require extra bandwidth, load balancer 304 may adjust the bandwidth limit by reallocating the extra bandwidth to the one or more plurality of active devices that require extra bandwidth. In one embodiment, load balancer 304 does this by decreasing the bandwidth limit (ACTIVE BANDWIDTH LIMIT[M]) by the extra bandwidth from those devices that have extra bandwidth, and by increasing the bandwidth limit (ACTIVE BANDWIDTH LIMIT[M]) of a select set of the one or more plurality of active devices that require extra bandwidth. In one embodiment, the bandwidth limit is increased by an add count (ADD COUNT). In one embodiment, illustrated in examples below, the add count may be an amount based on the total extra bandwidth. In another embodiment, the add count may be an amount based on both the total extra bandwidth (TOTAL EXTRA BANDWIDTH), and on the required bandwidth for each device requiring more bandwidth For example, the total extra bandwidth could be allocated in an amount proportional to the amount of bandwidth needed by a given device.

The select set of the one or more of plurality of active devices that require extra bandwidth may include the total number of devices in the current iteration that require extra bandwidth (i.e., DEVICE COUNT+PRIORITY COUNT); the number of devices that require extra bandwidth because the initial bandwidth allocation is not enough (DEVICE COUNT); or the number of priority devices (PRIORITY COUNT). The select set may comprise one or more of the active devices. In illustrated embodiments, the select set of the one or more of the plurality of active devices that require extra bandwidth may include one of: one or more of the active devices that may require extra bandwidth because the initial bandwidth allocation is not enough (devices that contribute to DEVICE COUNT); or one or more of the active devices that are priority devices (devices that contribute to PRIORITY COUNT).

The method ends at block 414.

### Exemplary Embodiment

In an exemplary embodiment, the following load balancer 304 operations may result from each iteration:

1. Set DEVICE COUNT to determine if there are any active devices (402).

DEVICE COUNT may be set to the total number of devices where TOTAL REQUESTED BANDWIDTH[M]>0 (i.e., QUEUE BANDWIDTH[M]>0, or ACTIVE BANDWIDTH[M]>0).

TOTAL REQUESTED BANDWIDTH[M]=QUEUE BANDWIDTH[M]+ACTIVE BANDWIDTH[M].

2. If there are no active devices (404, e.g., if DEVICE COUNT=0), then for each device M of 0-N devices, set ACTIVE BANDWIDTH LIMIT [M]=MAX BANDWIDTH−RES BANDWIDTH.

If there are one or more active devices (406, e.g., DEVICE COUNT>0), then set ACTIVE BANDWIDTH LIMIT[M]=AVG BANDWIDTH for the one or more active devices.

AVG BANDWIDTH=(MAX BANDWIDTH−RES BANDWIDTH)/DEVICE COUNT.

If AVG BANDWIDTH<MIN BANDWIDTH, then set AVG BANDWIDTH=MIN BANDWIDTH.

If there are one or more active devices, and any remaining devices that are not active, then set ACTIVE BANDWIDTH LIMIT[M]=0 for the remaining devices that are not active. (These remaining inactive devices may still use RES BANDWIDTH if they require extra bandwidth during the current iteration.)

3. For each active device, determine the total extra bandwidth, and the number of devices requiring extra bandwidth (408).

Reset DEVICE COUNT=0, and set PRIORITY COUNT=0.

Extra bandwidth: for each active device M,

If TOTAL REQUESTED BANDWIDTH[M]<ACTIVE BANDWIDTH LIMIT[M], then GIVE BANDWIDTH[M]=(ACTIVE BANDWIDTH LIMIT[M]−TOTAL REQUESTED BANDWIDTH[M]).

TOTAL EXTRA BANDWIDTH=Σ(0-N)(GIVE BANDWIDTH[M]).

Devices requiring extra bandwidth—for each active device M:

If TOTAL REQUESTED BANDWIDTH[M]>ACTIVE BANDWIDTH LIMIT[M], then DEVICE COUNT=DEVICE COUNT+1.

If PRIORITY[M]=1, then PRIORITY COUNT=PRIORITY COUNT+1.

4. If there is extra bandwidth, and devices that require extra bandwidth (i.e., (TOTAL EXTRA BANDWIDTH>0) AND (DEVICE COUNT>0 OR PRIORITY COUNT>0)) (410), then determine an amount that may be added (ADD COUNT) to the ACTIVE BANDWIDTH LIMIT[M] for the one or more of the devices that require extra bandwidth. In embodiments of the invention, priority devices may have higher priority than other devices requiring more bandwidth. Therefore, if there are priority devices, these devices may share in the extra bandwidth to the exclusion of other active devices requiring extra bandwidth. If there are no priority devices, then the devices requiring more bandwidth may share in the extra bandwidth:

If PRIORITY COUNT>0, then ADD COUNT=TOTAL EXTRA BANDWIDTH/PRIORITY COUNT.

If PRIORITY COUNT=0, then ADD COUNT=TOTAL EXTRA BANDWIDTH/DEVICE COUNT.

In embodiments of the invention, the total ACTIVE BANDWIDTH LIMIT[M] should not exceed (MAX BANDWIDTH—RES BANDWIDTH), so numbers may be rounded down to the next whole number, if necessary.

5. Decrease the ACTIVE BANDWIDTH LIMIT[M] for those devices that have extra bandwidth (412) by GIVE BANDWIDTH[M], and increase the ACTIVE BANDWIDTH LIMIT[M] of one or more of the active devices requiring extra bandwidth by ADD COUNT (412).

ACTIVE BANDWIDTH LIMIT[M] for each of the devices that have extra bandwidth is decreased by a corresponding GIVE BANDWIDTH[M].

If PRIORITY COUNT>0, then ACTIVE BANDWIDTH LIMIT[M]=ACTIVE BANDWIDTH LIMIT[M]+ADD COUNT for each priority device (e.g., devices where PRIORITY[M]=1, those that contributed to PRIORITY COUNT). This may be the amount of bandwidth that may be added to each priority device's ACTIVE BANDWIDTH LIMIT[M] to allow it to use more bandwidth.

If PRIORITY COUNT=0, then ACTIVE BANDWIDTH LIMIT[M]=ACTIVE BANDWIDTH LIMIT[M]+ADD COUNT for each device requiring more bandwidth by virtue of having more requests than allocated (i.e., those that contributed to DEVICE COUNT). This may be the total amount of bandwidth that may be added to each device's ACTIVE BANDWIDTH LIMIT[M] to allow it to use more bandwidth.

Load balancer 304 may allocate ACTIVE BANDWIDTH LIMIT[M] to each device (416). Device request controller 306 may use this information to control the sending of requests from controller 302 to devices 308A . . . 308N.

### EXAMPLE 1

### No Devices Associated with a Priority

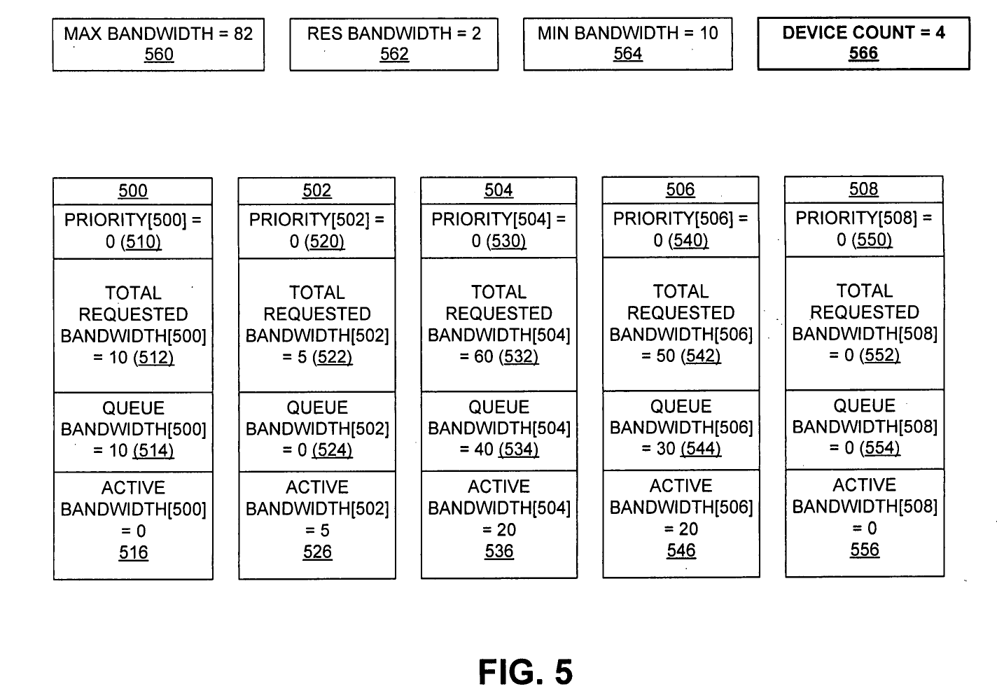

FIGS. 5-8 illustrate a first example of the exemplary embodiment described above. In this example, MAX BANDWIDTH=82 (560), RES BANDWIDTH=2 (562), MIN BANDWIDTH=10 (564) and devices 500, 502, 504, 506, 508 are attached to controller 302 (not shown in this example).

FIG. 5 illustrates the following:

None of the devices 500, 502, 504, 506, 508 have their priority flag set (PRIORITY[500]=0 (510); PRIORITY[502]=0 (520); PRIORITY[504]=0 (530); PRIORITY[506]=0 (540); PRIORITY[508]=0 (550)).

Device 500 may have a total requested bandwidth 512 of 10 requests (QUEUE BANDWIDTH=10 (514); ACTIVE BANDWIDTH=0 (516)).

Device 502 may have a total requested bandwidth 522 of 5 requests (QUEUE BANDWIDTH=0 (524); ACTIVE BANDWIDTH=5 (526).

Device 504 may have a total requested bandwidth 532 of 60 requests (QUEUE BANDWIDTH=40 (534); ACTIVE BANDWIDTH=20 (536)).

Device 506 may have a total requested bandwidth 542 of 50 requests (QUEUE BANDWIDTH=30 (544); ACTIVE BANDWIDTH=20 (546)).

Device 508 may have a total requested bandwidth 552 of 0 requests (QUEUE BANDWIDTH=0 (554); ACTIVE BANDWIDTH=0 (556)).

1. Set DEVICE COUNT to determine if there are any active devices.

DEVICE COUNT may be set to the total number of devices where TOTAL REQUESTED BANDWIDTH[M]>0 (i.e., QUEUE BANDWIDTH[M]>0, or ACTIVE BANDWIDTH[M]>0).

TOTAL REQUESTED BANDWIDTH[M]=QUEUE BANDWIDTH[M]+ACTIVE BANDWIDTH[M].

TOTAL REQUESTED BANDWIDTH[500] (512)=10+0=10.

TOTAL REQUESTED BANDWIDTH[502] (522)=0+5=5.

TOTAL REQUESTED BANDWIDTH[504] (532)=40+20=60.

TOTAL REQUESTED BANDWIDTH[506] (542)=30+20=50.

TOTAL REQUESTED BANDWIDTH[508] (552)=0+0=0.

DEVICE COUNT=4 (566) (500, 502, 504, 506).

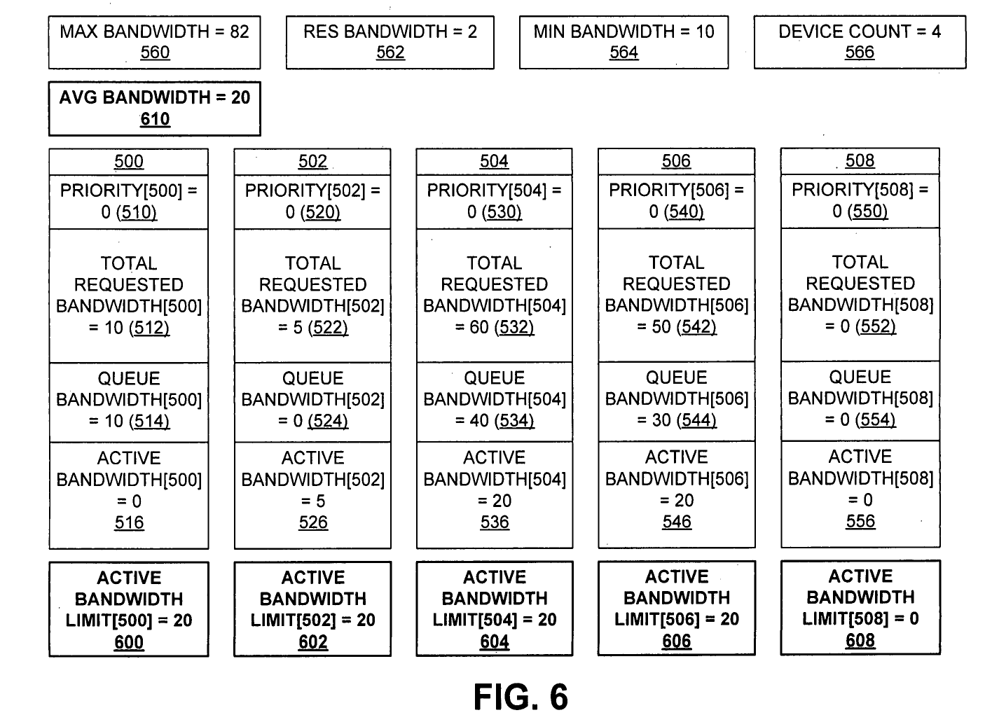

FIG. 6 illustrates the following:

2. If there are no active devices (e.g., if DEVICE COUNT=0), then for each device M of 0-N devices, set ACTIVE BANDWIDTH LIMIT [M]=MAX BANDWIDTH−RES BANDWIDTH.

Not applicable, since there are four (4) active devices.

If there are one or more active devices (e.g., DEVICE COUNT>0), then set ACTIVE BANDWIDTH LIMIT[M]=AVG BANDWIDTH for the one or more active devices.

AVG BANDWIDTH=(MAX BANDWIDTH−RES BANDWIDTH)/DEVICE COUNT.

AVG BANDWIDTH=(82−2)/4=80/4=20 (610).

AVG BANDWIDTH (610))>MIN BANDWIDTH (564).

ACTIVE BANDWIDTH LIMIT[500]=20 (600).

ACTIVE BANDWIDTH LIMIT[502]=20 (602).

ACTIVE BANDWIDTH LIMIT[504]=20 (604).

ACTIVE BANDWIDTH LIMIT[506]=20 (606).

If AVG BANDWIDTH<MIN BANDWIDTH, then set AVG BANDWIDTH=MIN BANDWIDTH.

Not applicable here because AVG BANDWIDTH (610)>MIN BANDWIDTH (564).

If there are one or more active devices, and any remaining devices that are not active, then set ACTIVE BANDWIDTH LIMIT[M]=0 for the remaining devices that are not active. (These remaining inactive devices may still use RES BANDWIDTH if they require extra bandwidth during the current iteration.)

ACTIVE BANDWIDTH LIMIT[508]=0 (608).

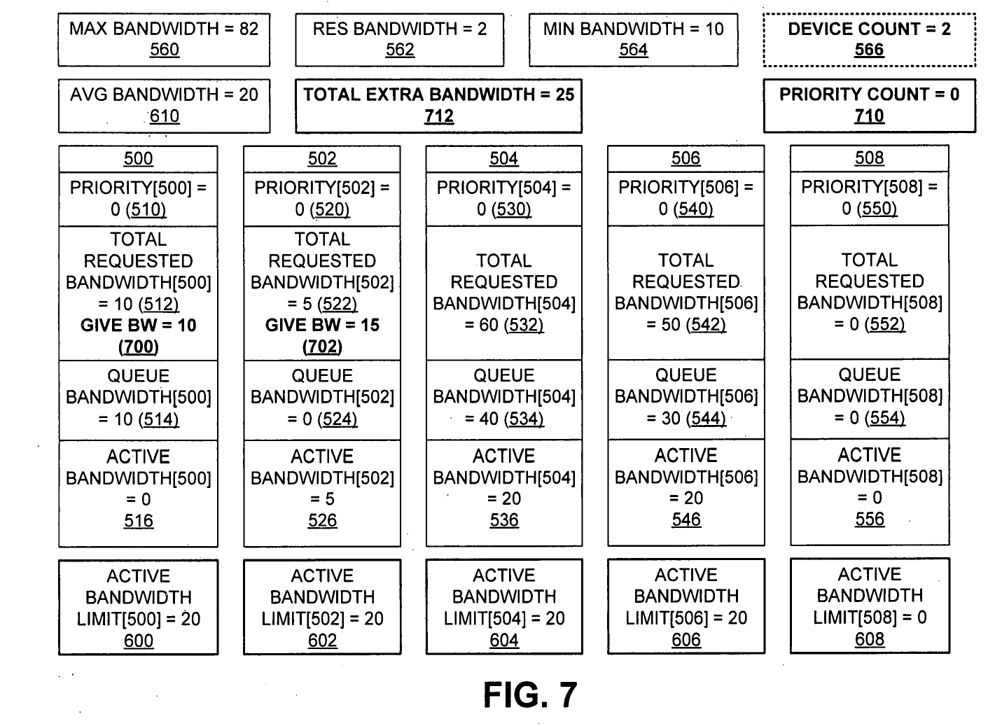

FIG. 7 illustrates the following:

3. For each active device, determine the total extra bandwidth, and the number of devices requiring extra bandwidth.

Reset DEVICE COUNT=0, and set PRIORITY COUNT=0.

Extra bandwidth: for each active device M,

If TOTAL REQUESTED BANDWIDTH[M]<ACTIVE BANDWIDTH LIMIT[M], then GIVE BANDWIDTH[M]=(ACTIVE BANDWIDTH LIMIT[M]−TOTAL REQUESTED BANDWIDTH[M]).

TOTAL REQUESTED BANDWIDTH[500] (512)<ACTIVE BANDWIDTH LIMIT[500] (610), so GIVE BANDWIDTH[500]=(20−10)=10 (700).

TOTAL REQUESTED BANDWIDTH[502] (5) (522)<ACTIVE BANDWIDTH LIMIT[502] (610), so GIVE BANDWIDTH[502]=(20−5)=15 (702).

TOTAL EXTRA BANDWIDTH=Σ(0-N)(GIVE BANDWIDTH[M]).

TOTAL EXTRA BANDWIDTH (712)=GIVE BANDWIDTH[500] (700)+GIVE BANDWIDTH[502] (702)=25.

Devices requiring extra bandwidth—for each active device M:

If TOTAL REQUESTED BANDWIDTH[M]>ACTIVE BANDWIDTH LIMIT[M], then DEVICE COUNT=DEVICE COUNT+1.

TOTAL REQUESTED BANDWIDTH[504] (532)>ACTIVE BANDWIDTH LIMIT[504] (604), so DEVICE COUNT=0+1.

If TOTAL REQUESTED BANDWIDTH[506] (542)>ACTIVE BANDWIDTH LIMIT[506] (606), so DEVICE COUNT=1+1.

DEVICE COUNT=2 (566).

If PRIORITY[M]=1, then PRIORITY COUNT=PRIORITY COUNT+1.

In this example, no devices have their priority flag set, so PRIORITY COUNT=0 (710).

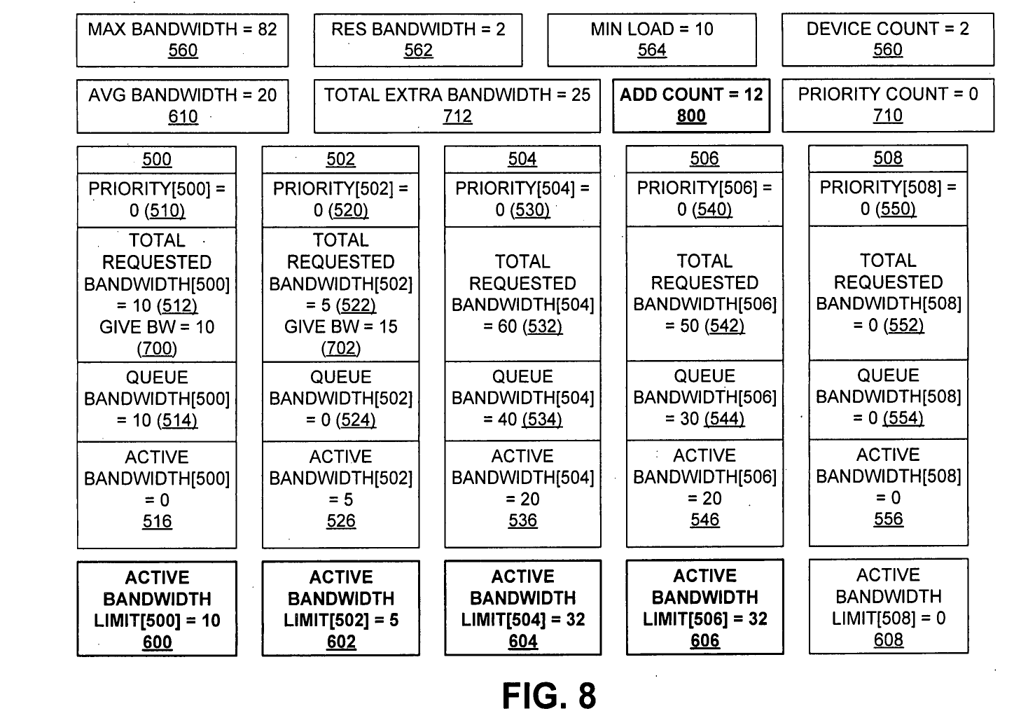

FIG. 8 illustrates the following:

4. If there is extra bandwidth, and devices that require extra bandwidth (i.e., (TOTAL EXTRA BANDWIDTH>0) AND (DEVICE COUNT>0 OR PRIORITY COUNT>0)), then determine an amount that may be added (ADD COUNT) to the ACTIVE BANDWIDTH LIMIT[M] for the one or more of the devices that require extra bandwidth. In embodiments of the invention, priority devices may have higher priority than other devices requiring more bandwidth. Therefore, if there are priority devices, these devices may share in the extra bandwidth to the exclusion of other active devices requiring extra bandwidth. If there are no priority devices, then the devices requiring more bandwidth may share in the extra bandwidth:

If PRIORITY COUNT>0, then ADD COUNT=TOTAL EXTRA BANDWIDTH/PRIORITY COUNT.

Here, no devices have their priority flags set.

If PRIORITY COUNT=0, then ADD COUNT=TOTAL EXTRA BANDWIDTH/DEVICE COUNT.

ADD COUNT=25/2=12.5).

In embodiments of the invention, the total ACTIVE BANDWIDTH LIMIT[M] should not exceed (MAX BANDWIDTH−RES BANDWIDTH), so numbers may be rounded up or down to the next whole number, as appropriate.

ADD COUNT=12 (800).

In this example, the number was rounded down, so the total allocated bandwidth=79 (10, 5, 32, 32)<(80−2=80).

5. Decrease the ACTIVE BANDWIDTH LIMIT[M] for those devices that have extra bandwidth by GIVE BANDWIDTH[M], and increase the ACTIVE BANDWIDTH LIMIT[M] of one or more of the active devices requiring extra bandwidth by ADD COUNT.

ACTIVE BANDWIDTH LIMIT[M] for each of the devices that have extra bandwidth is decreased by a corresponding GIVE BANDWIDTH[M].

ACTIVE BANDWIDTH LIMIT[500]=20−10=10 (600)

ACTIVE BANDWIDTH LIMIT[500]=20−15=5 (602)

If PRIORITY COUNT>0, then ACTIVE BANDWIDTH LIMIT[M]=ACTIVE BANDWIDTH LIMIT[M]+ADD COUNT for each priority device (e.g. devices where PRIORITY[M]=1, those that contributed to PRIORITY COUNT). This may be the amount of bandwidth that may be added to each priority device's ACTIVE BANDWIDTH LIMIT[M] to allow it to use more bandwidth.

Here, no devices have their priority flags set.

If PRIORITY COUNT=0, then ACTIVE BANDWIDTH LIMIT[M]=ACTIVE BANDWIDTH LIMIT[M]+ADD COUNT for each device requiring more bandwidth by virtue of having more requests than allocated (i.e., those that contributed to DEVICE COUNT). This may be the total amount of bandwidth that may be added to each device's ACTIVE BANDWIDTH LIMIT[M] to allow it to use more bandwidth.

ACTIVE BANDWIDTH LIMIT[504]=20+12=32 (604)

ACTIVE BANDWIDTH LIMIT[506]=20+12=32 (606).

In this example, load balancer 304 may allocate ten (10) requests to device 500, and five (5) requests to device 502 and thirty-two (32) requests to device 504 and device 506. Controller 302 may use these allocations to pass requests to device 500, 502, 504, 506, 508.

### EXAMPLE 2

### Device Associated with a Priority

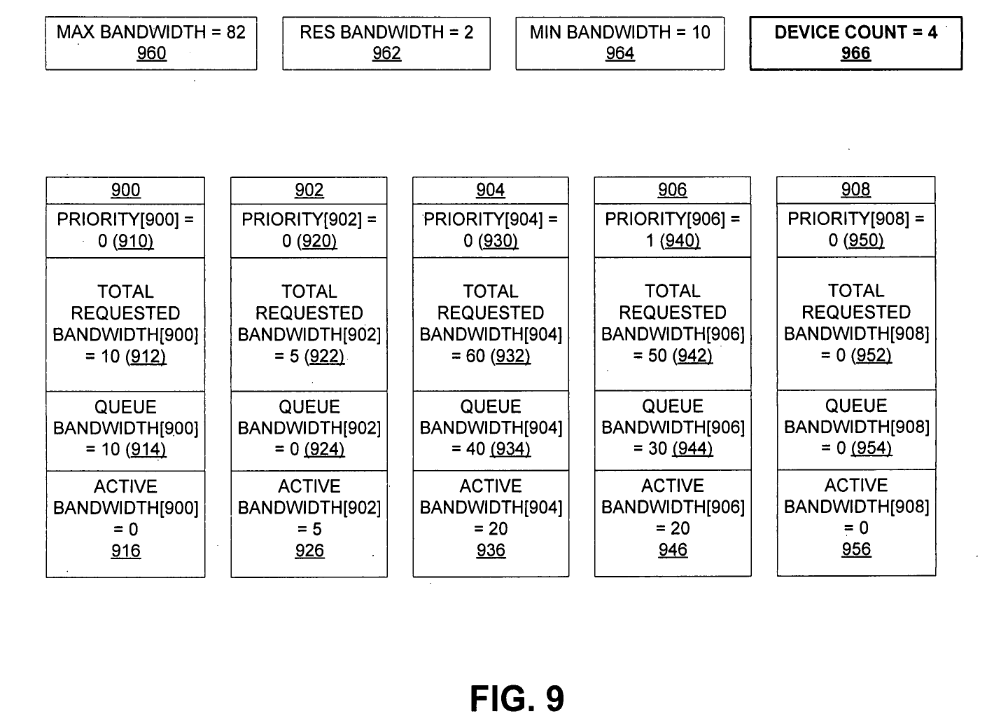

FIGS. 9-12 illustrate a second example of the exemplary embodiment described above. As in Example 1, MAX BANDWIDTH=82 (960), RES BANDWIDTH=2 (962), MIN BANDWIDTH=10 (964) and devices 900, 902, 904, 906, 908 are attached to the controller 302 (not shown in this example).

FIG. 9 illustrates the following:

Device 906 has its priority flag set (PRIORITY[906]=1 (940)). Devices 900, 902, 904, 908 do not have their priority flags set (PRIORITY[900]=0 (910); PRIORITY[902]=0 (920); PRIORITY[904]=0 (930); PRIORITY[908] (950)=0).

Device 900 may have a total requested bandwidth 912 of 10 requests (QUEUE BANDWIDTH=10 (914); ACTIVE BANDWIDTH=0 (916)).

Device 902 may have a total requested bandwidth 922 of 5 requests (QUEUE BANDWIDTH=0 (924); ACTIVE BANDWIDTH 926=5).

Device 904 may have a total requested bandwidth 932 of 60 requests (QUEUE BANDWIDTH=40 (934); ACTIVE BANDWIDTH=20 (936)).

Device 906 may have a total requested bandwidth 942 of 50 requests (QUEUE BANDWIDTH=30 (944); ACTIVE BANDWIDTH=20 (946)).

Device 908 may have a total requested bandwidth 952 of 0 requests (QUEUE BANDWIDTH=0 (954); ACTIVE BANDWIDTH=0 (956)).

1. Set DEVICE COUNT to determine if there are any active devices.

DEVICE COUNT may be set to the total number of devices where TOTAL REQUESTED BANDWIDTH[M]>0 (i.e. QUEUE BANDWIDTH[M]>0, or ACTIVE BANDWIDTH[M]>0).

TOTAL REQUESTED BANDWIDTH[M]=QUEUE BANDWIDTH [M]+ACTIVE BANDWIDTH[M].

TOTAL REQUESTED BANDWIDTH[900] (912)=10+0=10.

TOTAL REQUESTED BAND WIDTH[902] (922)=0+5=5.

TOTAL REQUESTED BANDWIDTH[904] (932)=40+20=60.

TOTAL REQUESTED BANDWIDTH[906] (942)=30+20=50.

TOTAL REQUESTED BANDWIDTH[908] (952)=0+0=0.

DEVICE COUNT=4 (966) (900, 902, 904, 906).

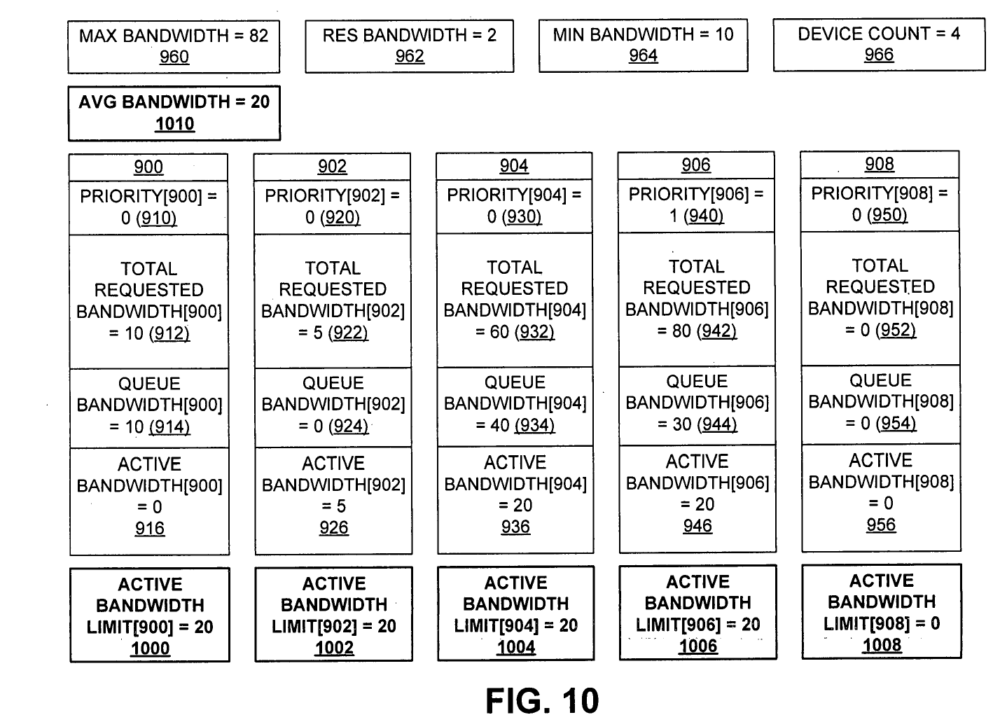

FIG. 10 illustrates the following:

2. If there are no active devices (e.g., if DEVICE COUNT=0), then for each device M of 0-N devices, set ACTIVE BANDWIDTH LIMIT [M]=MAX BANDWIDTH−RES BANDWIDTH.

Not applicable, since there are four (4) active devices.

If there are one or more active devices (e.g., DEVICE COUNT>0), then set ACTIVE BANDWIDTH LIMIT[M]=AVG BANDWIDTH for the one or more active devices.

AVG BANDWIDTH=(MAX BANDWIDTH−RES BANDWIDTH)/DEVICE COUNT.

AVG BANDWIDTH=(82−2)/4=80/4=20 (1010).

AVG BANDWIDTH (1010)>MIN BANDWIDTH (964).

ACTIVE BANDWIDTH LIMIT[900]=20 (1000).

ACTIVE BANDWIDTH LIMIT[902]=20 (1002).

ACTIVE BANDWIDTH LIMIT[904]=20 (1004).

ACTIVE BANDWIDTH LIMIT[906]=20 (1006).

If AVG BANDWIDTH<MIN BANDWIDTH, then set AVG BANDWIDTH=MIN BANDWIDTH.

Not applicable here because AVG BANDWIDTH (1010)>MIN BANDWIDTH (964).

If there are one or more active devices, and any remaining devices that are not active, then set ACTIVE BANDWIDTH LIMIT[M]=0 for the remaining devices that are not active. (These remaining inactive devices may still use RES BANDWIDTH if they require extra bandwidth during the current iteration.)

ACTIVE BANDWIDTH LIMIT[908]=0 (1008).

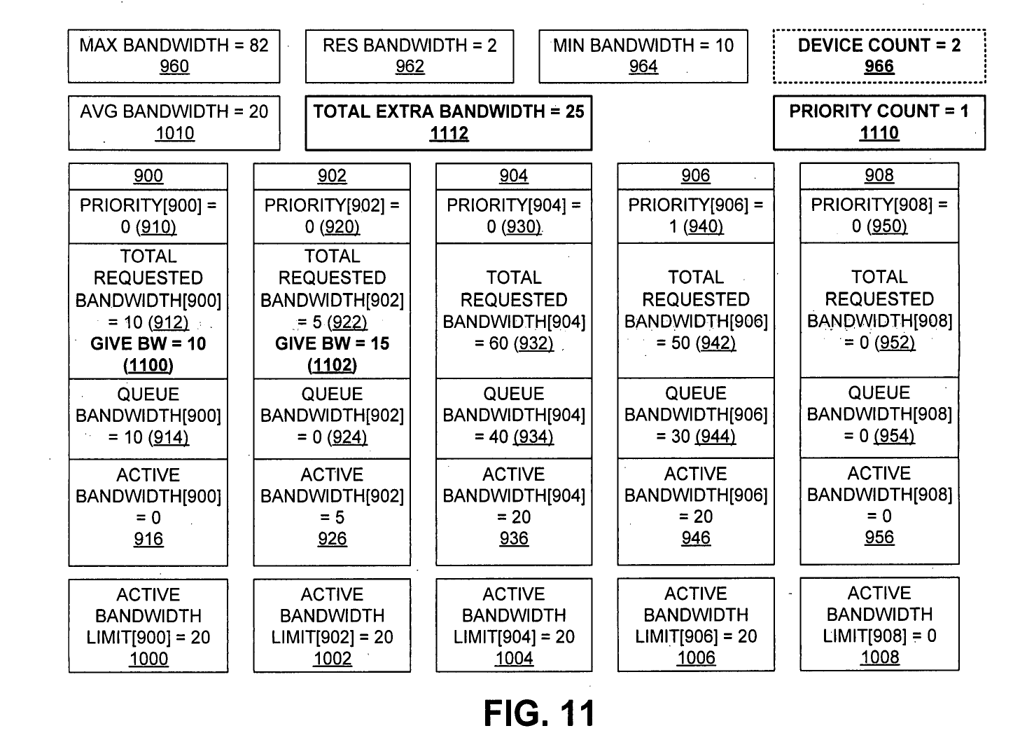

FIG. 11 illustrates the following:

3. For each active device, determine the total extra bandwidth, and the number of devices requiring extra bandwidth.

Reset DEVICE COUNT=0, and set PRIORITY COUNT=0.

Extra bandwidth: for each active device M

If TOTAL REQUESTED BANDWIDTH[M]<ACTIVE BANDWIDTH LIMIT[M], then GIVE BANDWIDTH[M]=(ACTIVE BANDWIDTH LIMIT[M]−TOTAL REQUESTED BANDWIDTH[M]).

TOTAL REQUESTED BANDWIDTH[900] (912)<ACTIVE BANDWIDTH LIMIT[900] (1000), so GIVE BANDWIDTH[900]=(20−10)=10 (1100).

TOTAL REQUESTED BANDWIDTH[902] (922)<ACTIVE BANDWIDTH LIMIT[902] (1002), so GIVE BAND WIDTH[902]=(20−5)=15 (1102).

TOTAL EXTRA BANDWIDTH=Σ(0-N)(GIVE BANDWIDTH[M]).

TOTAL EXTRA BANDWIDTH (1112)=GIVE BANDWIDTH[900] (1100)+GIVE BANDWIDTH[902] (1102)=25.

Devices requiring extra bandwidth—for each active device M:

If TOTAL REQUESTED BANDWIDTH[M]>ACTIVE BANDWIDTH LIMIT[M], then DEVICE COUNT=DEVICE COUNT+1.

TOTAL REQUESTED BANDWID TH[904] (932)>ACTIVE BANDWIDTH LIMIT[904] (1004), so DEVICE COUNT=0+1.

If TOTAL REQUESTED BANDWIDTH[906] (942)>ACTIVE BANDWIDTH LIMIT[906] (1006), so DEVICE COUNT=1+1.

DEVICE COUNT=2 (966).

If PRIORITY[M]=1, then PRIORITY COUNT=PRIORITY COUNT+1.

PRIORITY[906]=1 (940).

PRIORITY COUNT=0+1=1 (1110).

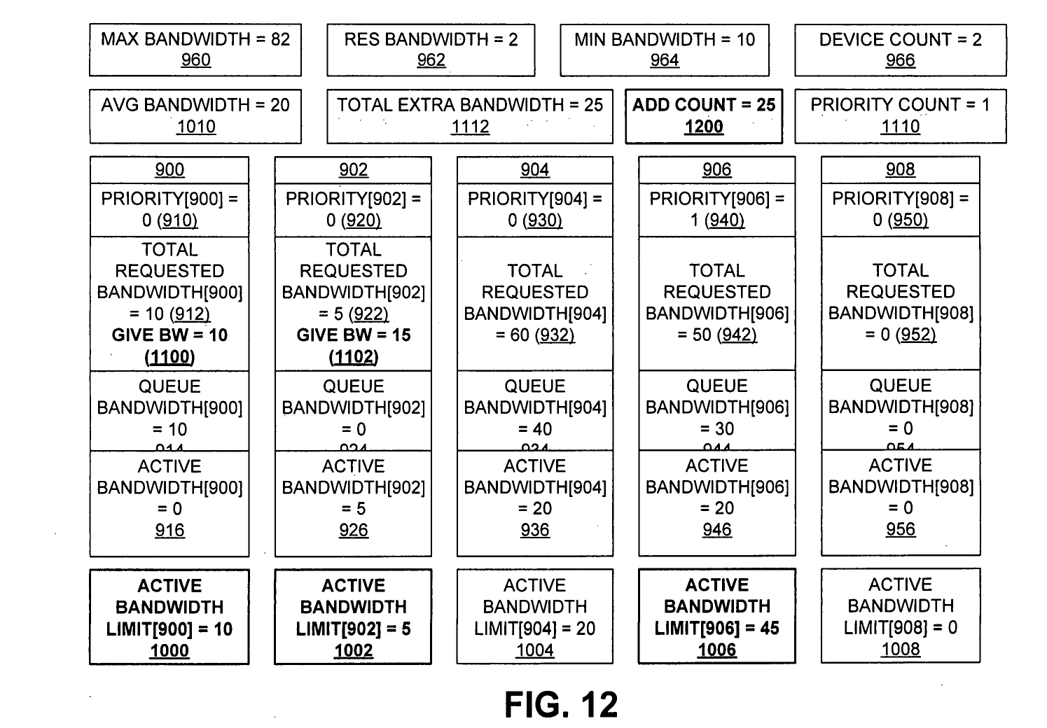

FIG. 12 illustrates the following:

4. If there is extra bandwidth, and devices that require extra bandwidth (i.e., (TOTAL EXTRA BANDWIDTH>0) AND (DEVICE COUNT>0 OR PRIORITY COUNT>0)), then determine an amount that may be added (ADD COUNT) to the ACTIVE BANDWIDTH LIMIT[M] for the one or more of the devices that require extra bandwidth. In embodiments of the invention, priority devices may have higher priority than other devices requiring more bandwidth. Therefore, if there are priority devices, these devices may share in the extra bandwidth to the exclusion of other active devices requiring extra bandwidth. If there are no priority devices, then the devices requiring more bandwidth may share in the extra bandwidth:

If PRIORITY COUNT>0, then ADD COUNT=TOTAL EXTRA BANDWIDTH/PRIORITY COUNT.

ADD COUNT=25/1=25 (1200).

If PRIORITY COUNT=0, then ADD COUNT=TOTAL EXTRA BANDWIDTH/DEVICE COUNT.

Here, PRIORITY COUNT>0, so this calculation is not used.

In embodiments of the invention, the total ACTIVE BANDWIDTH LIMIT[M] should not exceed (MAX BANDWIDTH−RES BANDWIDTH), so numbers may be rounded up or down to the next whole number, as appropriate.

Adjustment not needed here.

5. Decrease the ACTIVE BANDWIDTH LIMIT[M] for those devices that have extra bandwidth (412) by GIVE BANDWIDTH[M], and increase the ACTIVE BANDWIDTH LIMIT[M] of one or more of the active devices requiring extra bandwidth by ADD COUNT (414).

ACTIVE BANDWIDTH LIMIT[M] for each of the devices that have extra bandwidth is decreased by a corresponding GIVE BANDWIDTH[M].

ACTIVE BANDWIDTH LIMIT[900]=10 (1000).

ACTIVE BANDWIDTH LIMIT[902]=5 (1002).

If PRIORITY COUNT>0, then ACTIVE BANDWIDTH LIMIT[M]=ACTIVE BANDWIDTH LIMIT[M]+ADD COUNT for each priority device (e.g., devices where PRIORITY[M]=1, those that contributed to PRIORITY COUNT). This may be the amount of bandwidth that may be added to each priority device's ACTIVE BANDWIDTH LIMIT[M] to allow it to use more bandwidth.

ACTIVE BANDWIDTH LIMIT[906]=20+25=45 (1006).

If PRIORITY COUNT=0, then ACTIVE BANDWIDTH LIMIT[M]=ACTIVE BANDWIDTH LIMIT[M]+ADD COUNT for each device requiring more bandwidth by virtue of having more requests than allocated (i.e., those that contributed to DEVICE COUNT). This may be the total amount of bandwidth that may be added to each device's ACTIVE BANDWIDTH LIMIT[M] to allow it to use more bandwidth.

Here, PRIORITY COUNT>0, so this calculation is not used.

In this example, load balancer 304 may allocate ten (10) requests to device 900, five (5) requests to device 902, twenty (20) requests to device 904, and forty-five (45) requests to device 906. Controller 302 may use these allocations to pass requests to device 900, 902, 904, 906, 908.

### Conclusion

Thus, one method embodiment may comprise setting an initial bandwidth limit for each of a plurality of active devices associated with a controller. The method may additionally include determining a total amount of extra bandwidth from the plurality of active devices that have extra bandwidth, and determining a number of the plurality of active devices that require extra bandwidth. If there is extra bandwidth, and one or more of the plurality of active devices require extra bandwidth, adjusting the bandwidth limit by reallocating the extra bandwidth to the one or more plurality of active devices that require extra bandwidth, the adjusting resulting in a bandwidth limit corresponding to each of the plurality of active devices.

The embodiments described herein may provide a fair method of balancing the load on a plurality of devices that are trying to access a fixed amount of bandwidth, such as on a controller. By determining and using extra bandwidth, and by strategically allocating extra bandwidth to devices requiring more bandwidth, embodiments of the invention may reduce and/or eliminate the possibility of one or some of the devices capturing a significant amount of the total bandwidth, unfairly limiting the bandwidth available to other devices, and decreasing overall performance.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method comprising:
setting an initial bandwidth limit for each of a plurality of active devices associated with a controller;
determining a total amount of extra bandwidth from the plurality of active devices that have extra bandwidth, and determining a number of the plurality of active devices that require extra bandwidth; and
if there is extra bandwidth, and one or more of the plurality of active devices require extra bandwidth, adjusting the initial bandwidth limit by reallocating the extra bandwidth to the one or more plurality of active devices that require extra bandwidth, the adjusting resulting in a bandwidth limit corresponding to each of the plurality of active devices.

2. The method of claim 1, the method additionally comprising for each of the plurality of active devices, allocating the corresponding bandwidth limit to each of the plurality of active devices.

3. The method of claim 1, wherein the initial bandwidth limit is set to an average bandwidth.

4. The method of claim 3, wherein the initial bandwidth limit is additionally set to at least a minimum bandwidth.

5. The method of claim 1, wherein said reallocating the extra bandwidth from the one or more plurality of devices that have extra bandwidth to the one or more plurality of active devices that require extra bandwidth comprises:
decreasing the initial bandwidth limit by the extra bandwidth from the plurality of active devices that have extra bandwidth; and
increasing the initial bandwidth limit by an amount based on the extra bandwidth for a select set of the one or more plurality of active devices that require extra bandwidth.

6. The method of claim 5, wherein said increasing the initial bandwidth limit by an amount based on the extra bandwidth comprises determining an add count based on the select set of the one or more plurality of active devices that require extra bandwidth.

7. The method of claim 6, wherein the select set comprises at least one of the following:
at least one of one or more of the plurality of active devices that has a total requested bandwidth greater than the average bandwidth; and
at least one of one or more of the plurality of active devices that is associated with a priority.

8. The method of claim 7, wherein the total requested bandwidth for a given one of the plurality of active devices comprises an amount of bandwidth to be sent from the given active device to the controller, and an amount of bandwidth already sent from the given active device to the controller.

9. The method of claim 1, additionally determining a reserved bandwidth, and deducting the reserved bandwidth from a maximum bandwidth prior to setting the initial bandwidth limit for the plurality of active devices.

10. A method comprising:
determining from among a plurality of devices associated with a controller if any of the plurality of devices is an active device;
if one or more of the plurality of devices is an active device:
setting an initial bandwidth limit for each of the one or more active devices;
determining a total amount of extra bandwidth from the one or more active devices that have extra bandwidth, and determining a number of the one or more active devices that require extra bandwidth; and
if there is extra bandwidth, and one or more of the plurality of active devices require extra bandwidth, adjusting the initial bandwidth limit by reallocating the extra bandwidth to the one or more plurality of active devices that require extra bandwidth, the adjusting resulting in a bandwidth limit corresponding to each of the plurality of active devices; and
if none of the plurality of devices is an active device, then setting the bandwidth limit for each of the plurality of devices to an adjusted maximum bandwidth.

11. The method of claim 10, the method additionally comprising for each of the one or more active devices, allocating the corresponding bandwidth limit.

12. The method of claim 11, additionally comprising:
if one or more of the plurality of devices is an active device, and one or more of the plurality of devices is not an active device, allocating a bandwidth limit of zero for each of the one or more plurality of devices that is not an active device.

13. The method of claim 10, additionally determining a reserved bandwidth, and deducting the reserved bandwidth from a maximum bandwidth prior to setting the initial bandwidth limit for the one or more active devices.

14. The method of claim 13, wherein the reserved bandwidth is available to any of the plurality of devices that is not an active device.

15. An apparatus comprising:
circuitry that is capable of:
setting an initial bandwidth limit for each of a plurality of active devices associated with a controller;
determining a total amount of extra bandwidth from the plurality of active devices that have extra bandwidth, and determining a number of the plurality of active devices that require extra bandwidth; and
if there is extra bandwidth, and one or more of the plurality of active devices require extra bandwidth, adjusting the initial bandwidth limit by reallocating the extra bandwidth to the one or more plurality of active devices that require extra bandwidth, the adjusting resulting in a bandwidth limit corresponding to each of the plurality of active devices

16. The apparatus of claim 15, said circuitry additionally capable of allocating the corresponding bandwidth limit to each of the plurality of active devices.

17. The apparatus of claim 15, wherein the select set comprises at least one of the following:
at least one of one or more of the plurality of active devices that has a total requested bandwidth greater than the average bandwidth; and
at least one of one or more of the plurality of active devices that is associated with a priority.

18. The apparatus of claim 17, wherein the total requested bandwidth for a given one of the plurality of active devices comprises an amount of bandwidth to be sent from the given active device to the controller, and an amount of bandwidth already sent from the given active device to the controller.

19. The apparatus of claim 15, said circuitry additionally capable of determining a reserved bandwidth, and deducting the reserved bandwidth from a maximum bandwidth prior to setting the initial bandwidth limit for the plurality of active devices.

20. A system comprising:
a storage controller; and
a driver capable of:
setting an initial bandwidth limit for each of a plurality of active devices associated with a controller;
determining a total amount of extra bandwidth from the plurality of active devices that have extra bandwidth, and determining a number of the plurality of active devices that require extra bandwidth; and
if there is extra bandwidth, and one or more of the plurality of active devices require extra bandwidth, adjusting the initial bandwidth limit by reallocating the extra bandwidth to the one or more plurality of active devices that require extra bandwidth, the adjusting resulting in a bandwidth limit corresponding to each of the plurality of active devices

21. The system of claim 20, said driver additionally capable of allocating the corresponding bandwidth limit to each of the plurality of active devices.

22. The system of claim 20, wherein the select set comprises at least one of the following:
at least one of one or more of the plurality of active devices that has a total requested bandwidth greater than the average bandwidth; and
at least one of one or more of the plurality of active devices that is associated with a priority.

23. The system of claim 20, said driver additionally capable of determining a reserved bandwidth, and deducting the reserved bandwidth from a maximum bandwidth prior to setting the initial bandwidth limit for the plurality of active devices.

24. The system of claim 20, wherein bandwidth comprises a number of I/O (input/output) requests sent to a storage controller from a plurality of peripheral storage devices.

25. A machine-readable medium having stored thereon instructions, the instructions when executed by a machine, result in the following:
setting an initial bandwidth limit for each of a plurality of active devices associated with a controller;
determining a total amount of extra bandwidth from the plurality of active devices that have extra bandwidth, and determining a number of the plurality of active devices that require extra bandwidth; and
if there is extra bandwidth, and one or more of the plurality of active devices require extra bandwidth, adjusting the initial bandwidth limit by reallocating the extra bandwidth to the one or more plurality of active devices that require extra bandwidth, the adjusting resulting in a bandwidth limit corresponding to each of the plurality of active devices

26. The machine-readable medium of claim 25, wherein said instructions additionally result in allocating the corresponding bandwidth limit to each of the plurality of active devices.

27. The machine-readable medium of claim 25, wherein said instructions that result in increasing the initial bandwidth limit based on the extra bandwidth additionally result in determining an add count based on the select set of the one or more plurality of active devices that require extra bandwidth.

28. The machine-readable medium of claim 25, wherein the select set comprises at least one of the following:
at least one of one or more of the plurality of active devices that has a total requested bandwidth greater than the average bandwidth; and
at least one of one or more of the plurality of active devices that is associated with a priority.

29. The machine-readable medium of claim 28, wherein the total requested bandwidth for a given one of the plurality of devices comprises an amount of bandwidth to be sent from the given active device to the controller, and an amount of bandwidth already sent from the given active device to the controller.

30. The machine-readable medium of claim 25, wherein said instructions additionally result in determining a reserved bandwidth, and in deducting the reserved bandwidth from a maximum bandwidth prior to setting the initial bandwidth limit for the plurality of active devices.
